(19) United States
(12) Patent Application Publication
(10) Pub. No.: US 2010/0237999 A1
(43) Pub. Date: Sep. 23, 2010

(54) RADIO FREQUENCY TRANSPONDER AND RADIO FREQUENCY IDENTIFICATION SYSTEM

(75) Inventor: Achim Hilgers, Alsdorf (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/743,043

(22) PCT Filed: Nov. 12, 2008
(86) PCT No.: PCT/IB08/54734

§ 371 Date: May 14, 2010

(30) Foreign Application Priority Data
Nov. 16, 2007 (EP) 07120854.0

(51) Int. Cl. H04Q 5/22; H01Q 9/04

(52) U.S. Cl. 340/10.1; 343/700 MS

(57) ABSTRACT

A radio frequency transponder (1) comprising a substrate (2); an integrated circuit (3) disposed on said substrate (2); and an antenna (4) disposed on said substrate (2) and coupled to the integrated circuit (3); wherein the antenna (4) comprises a first conducting arm (4.1) having a substantially U-shaped structure and a second conducting arm (4.2) having an at least partly meander-shaped structure.

### FIELD OF THE INVENTION

The invention relates to radio frequency transponders and to radio frequency identification systems.

### BACKGROUND OF THE INVENTION

Radio frequency identification (RFID) is becoming a well established technology for identifying or tracking objects, materials and in future applications even animals or human beings in different branches of industry. RFID technology is considered a complement and likely an eventual replacement for bar code technology as RFID technology overcomes certain recognized bar code limitations. E.g. a visual line of sight between a reader and tagged RFID object is not necessary. Said technology is especially suited to transmit data (“information”) via a wireless communication link, so any disturbing cables are needed. Transmission systems based on said RFID technology are referred to as Radio Frequency Identification (RFID) Systems.

Said RFID Systems are divided up in low-frequency and high frequency systems, whereas the low frequency systems have a transmission frequency below 800 MHz and are usually based on inductive coupling principles, which are used to operate at resonance according to connecting a suited capacitor to the coupling-coil. Said low frequency systems are suited for low ranges between a few centimetres up to about 1 m. Said high frequency systems are operating at frequencies higher than 800 MHz and are suited for data transmissions up to a few meters.

A RFID system comprises a RFID reader and a radio frequency transponder. Said radio frequency transponder is an electronic device which is used to identify said products, animals or humans. Basically, said radio frequency transponders can be divided in active and passive transponders, where said active transponders comprise an internal power source and said passive transponders are powered by the RF-field, produced by the RFID reader. In addition to that semi-active or semi-passive transponders are known, which are using their own energy source only on demand or in case of transmitting.

Said radio frequency transponder consist of a substrate and an integrated circuit disposed on said substrate, which saves information in form of data. Said integrated circuit may include a preferably hardwired microprocessor, which is usually programmable and can be rewritten by means of said RFID-reader. In addition to that, said radio frequency transponder consists of a radio frequency antenna being coupled to said integrated circuit. Said antenna has to be adapted to the integrated circuit and to the operating frequency band, which can be the UHF frequency band (Europe: 863 MHz to 868 MHz, US: 902 MHz to 928 MHz) or a higher ISM band such as e.g. 2.4 GHz. In addition, said RFID reader comprises at least one system antenna, which allows for data communication between said radio frequency transponder and the RFID reader itself.

Said integrated circuit is directly attached to the antenna by means of state-of-the-art techniques like wire-bonding, flip-chip, etc. The antenna itself consists of a highly conducting material such as copper, aluminum, silver, gold, etc. and is attached onto said substrate, e.g. plastic foils, printed circuit boards, ceramic or ferrite materials or even composites of the aforementioned materials.

To optimize the radiating efficiency of said antenna the RF-reflection between antenna and integrated circuit has to be reduced. To achieve that, the complex power matching condition has to be fulfilled, thus maximum power can be transferred between the source (“antenna”) and the load (“integrated circuit IC”). This condition is defined as follows:

Z_{ic}=Z*antenna

R_{ic}+j·X_{ic}=Rₐₙₜₑₙₙₐ−j·Xₐₙₜₑₙₙₐ

This means that for perfect matching the absolute values of the real- and imaginary parts of the load (“integrated circuit, is”) and source (“antenna”) have to be equal and the imaginary parts have to be conjugated to each other. Usually the impedance of the integrated circuit tends to have a capacitive behavior, i.e. the imaginary part (“X_{ic}”) of the integrated circuit is negative. That means for an efficient transponder design an antenna with an inductive tendency is needed, i.e. the imaginary part (“Xₐₙₜₑₙₙₐ”) of the antenna impedance should be positive and its absolute value should be equal to the imaginary part of the impedance of the integrated circuit. In this case and if additionally the real parts (“R_{ic}, Rₐₙₜₑₙₙₐ”) of the integrated circuit impedance and the antenna impedance are equal, “conjugate power matching” is realized, and a maximum of energy can be transferred between antenna and the integrated circuit. From an antenna-design point of view this also means, that the real- and the imaginary part of the complex antenna impedance has to be matched to the corresponding real- and imaginary part of the impedance of the integrated circuit. In addition, the radiation efficiency of the antenna has to be maximized.

Conventional transponder-designs usually have a dipole-like radiation performance, which is characterized by an omni-directional radiating pattern in a single polarization plane. Thus the dipole-like antenna has to be oriented in such a manner, that the RFID reader can make use of this omni-directional pattern. In contrast to that, the proposed transponder-design can be used independently on the chosen position and orientation in relation to the antenna of the RFID reader.

International patent application no. WO 2005/119587 A1 discloses a radio frequency identification tag attached to an object and comprising an antenna and an integrated circuit for providing object information to a separate reader. The antenna further comprises a pair of meanderline transmission lines each terminated at a first end for conductive connection to the integrated circuit. In addition to that, a shorting bar connected between said pair of meanderline transmission lines at the first end is operative to match the antenna impedance with the integrated circuit impedance in order to bypass the conductive connection to the integrated circuit.

Furthermore, International Patent Application No. WO-2007/047277 A2 discloses an RFID tag system comprising a reader having a transmit antenna and operable to transmit a signal to an RFID tag and an RFID tag including a circularly polarized antenna. Said tag antenna includes two crossed dipoles exhibiting an omnidirectional characteristic. Said dipoles are fed with signals having a relative phase angle of 90° provided by signal source coupled to a power splitter and a delay line for one output of the power splitter.

### OBJECT AND SUMMARY OF THE INVENTION

It is an object of the invention to provide a radio frequency transponder having a technical simple antenna structure providing a quasi-omnidirectional characteristic.

In order to achieve the object defined above, according to the invention a radio frequency transponder comprising a substrate, an integrated circuit disposed on said substrate and an antenna disposed on said substrate and coupled to the integrated circuit is provided, the antenna comprising a first conducting arm having a substantially U-shaped structure and a second conducting arm having an at least partly meander-shaped structure. Advantageously, said radio frequency transponder supports an excellent receiving behaviour, namely independent from the orientation and placement of the antenna of said RFID transponder. This unique feature is based on the “quasi”-omnidirectional radiation performance of the proposed antenna design.

Advantageously, said antenna comprises an asymmetrical antenna structure and is linear polarized.

Further advantageously, said method enables a higher integration capability by reducing the number of components, power and costs.

The integrated circuit is capable of providing information to a separate RFID reader via a wireless communication link and is connected to first ends of said first and second conducting arms.

Advantageously said first and second conducting arms comprise second ends being oriented in the same direction, whereas the first conducting arm comprises a total first electrical length and the second conducting arm a total second electrical length, which are of different length.

Further advantageously, the first conducting arm comprises a first, second and third conducting leg, wherein the first and third conducting legs are oriented in parallel and the second conducting leg is oriented vertically to the center line of the substrate.

In addition to that, the second conducting arm comprises a first, second, third, fourth and fifth conducting leg, wherein the first, third and fifth conducting legs are oriented in parallel and the second and fourth conducting legs are oriented vertically to the center line of the substrate.

These and other aspects of the invention are apparent from and will be elucidated with reference to the embodiments described hereinafter.

### BRIEF DESCRIPTION OF THE DRAWINGS

The invention will be described in greater detail hereinafter, by way of non-limiting examples, with reference to the embodiments shown in the drawings.

FIG. 1 shows a block diagram of an RFID transponder having a specific antenna design;

FIG. 2a-2c show three polar diagrames of the radiation pattern of the antenna design of FIG. 1.

### DESCRIPTION OF EMBODIMENTS

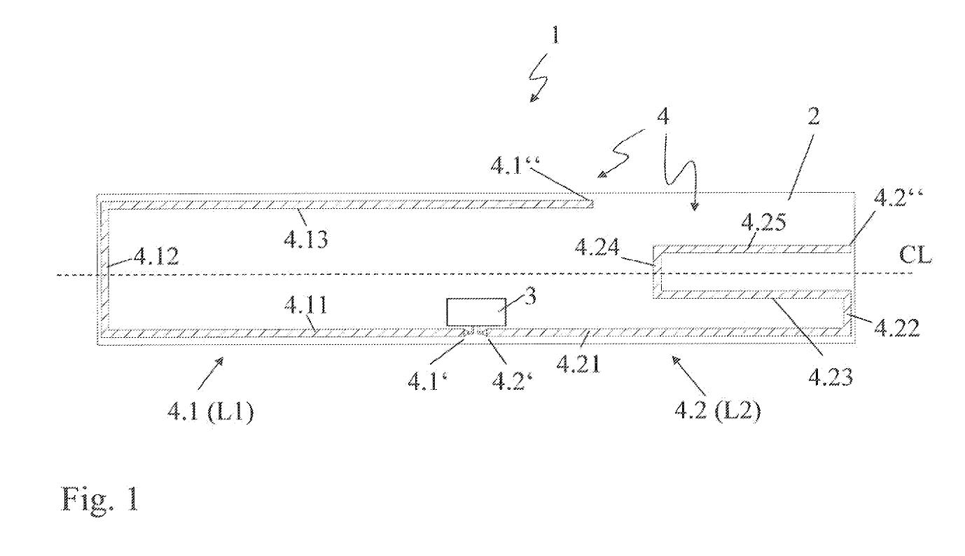

FIG. 1 shows per way of example a block diagram of a radio frequency identification (RFID) transponder 1 comprising a substrate 2 and an integrated circuit 3 disposed on said substrate 2, wherein said integrated circuit 3 is capable of providing information to a separate RFID reader via a wireless communication link (not shown in FIG. 1).

In addition to that an antenna 4 is disposed on said substrate 2. Said antenna 4 comprises a first conducting arm 4.1 and a second conducting arm 4.2, wherein said first conducting arm 4.1 comprises a first end 4.1′ connected to the integrated circuit 3 and said second conducting arm 4.2 comprises a first end 4.2′ also connected to the integrated circuit 3.

Instead of using two straight conducting arms as for the ordinary dipole, according to the invention an asymmetrical antenna structure is used comprising a first and second conducting arm 4.1, 4.2 at least twice bended. In order to match the imaginary part of the integrated circuit impedance the first arm 4.1 has a substantially U-shaped structure and the second arm 4.2 has an at least partly meander-shaped structure. In addition, said first and second arms 4.1, 4.2 comprise second ends 4,1″, 4.2″ which are oriented in the same direction.

The first conducting arm 4.1 has a total first electrical length L1 and the second conducting arm 4.2 has a total second electrical length L2, where the total first and second electrical lengths L1, L2 are different.

The first conducting arm 4.1 comprises a first, second and third conducting leg 4.11, 4.12, 4.13, wherein the first and third conducting legs 4.11, 4.13 are oriented in parallel to the center line CL of the substrate 2 and the second conducting leg 4.12 is oriented vertically to the center line CL of the substrate 2.

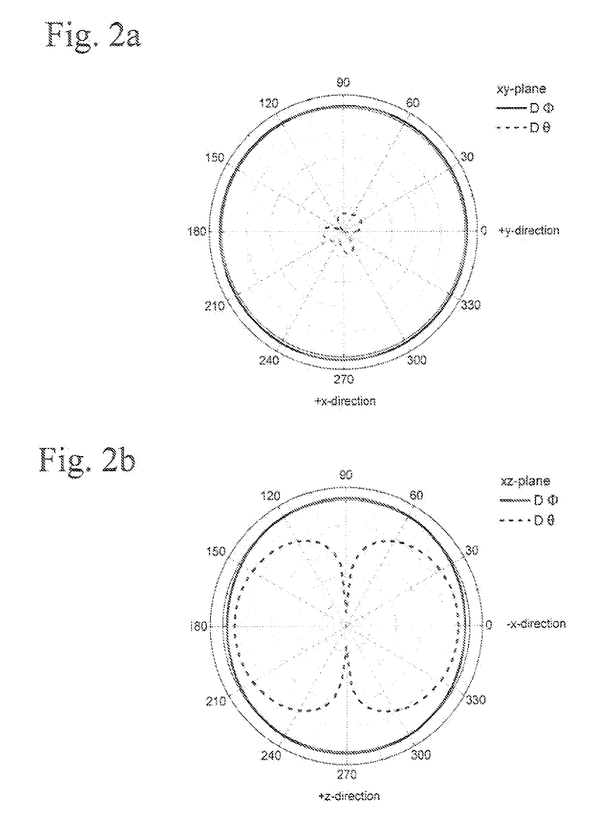

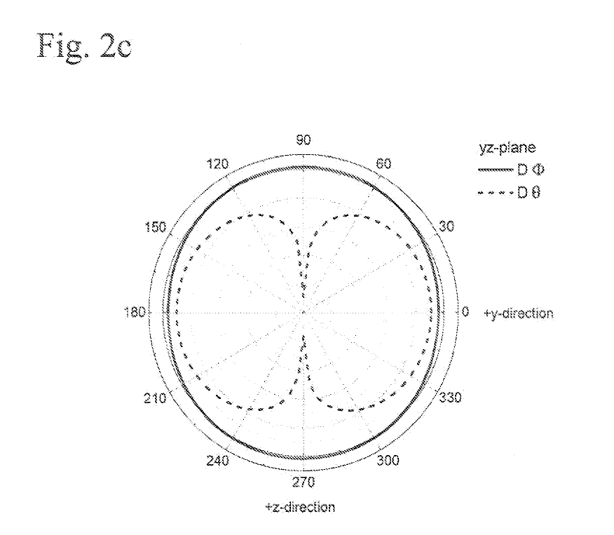

The second conducting arm 4.2 comprises a first, second, third, fourth and fifth conducting leg 4.21, 4.22, 4.23, 4.24, 4.25, wherein the first, third and fifth conducting legs 4.21, 4.23, 4.25 are oriented in parallel and the second and fourth conducting legs 4.22, 4.24 are oriented vertically to the center line CL of the substrate 2. In FIG. 2a-2c three polar diagrams are depicted showing the radiation performance of the antenna 4 in the three main planes (“xy-, xz- and yz-plane”). By way of example an operating frequency of 865 MHz has been chosen. In the polar diagrams the two linear polarizations (Φ) (phi, “solid line”) and Θ (theta, “dashed line”) are considered. The polar diagrams show that the presented antenna design shows a fairly good omni-directional radiation performance in all three main planes (“xy-, xz- and yz-plane”). Therefore, the RFID transponder 1 shows no dependency on the alignment of the antenna 4 in relation to a RFID system/reader antenna. So the presented capacitive couplings between the first and second conducting arms 4.1, 4.2 in combination with their self-inductance enables a fairly good match of the given integrated circuit impedance. No more coupling structures are needed as for an ordinary dipole based antenna.

Finally, it should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. A controller for controlling a lamp driver supplied with an output of a phase cut dimmer, said controller comprising:
enabling means configured to enable said lamp driver at a start time and disable said lamp driver a first time period (T1) after said start time and before the end of an active period of said dimmer;
first sensing means configured to sense said active period of said dimmer based on said output of said dimmer and to transmit a start signal to said enabling means, wherein said enabling means is further configured to enable said lamp driver when receiving said start signal;
second sensing means configured to sense a passive period of said dimmer based on said output of said dimmer and to generate a signal indicating said passive period, and
calculating means configured to calculate a proposed new first time period (TP1) based on said signal indicating said passive period and a signal indicating said first time period (T1),
and wherein said enabling means is further configured to adapt said first time period (T1) based on said proposed new first time period (TP1).

2. (canceled)

3. (canceled)

4. A controller according to claim 1, wherein said first sensing means is further configured to transmit said start signal at the beginning of said active period.

5. (canceled)

6. (canceled)

7. A controller according to claim 1, wherein said enabling means is further configured to supply said signal indicating said first time period (T1).

8. A controller according to claim 7, wherein said calculating means is further configured to determine a second time period (T2) between the end of said first time period (T1) and a point in time at which a mains voltage of said dimmer falls below a certain level, subtract said determined second time period (T2) from a reference time period and integrate a subtraction result to obtain said proposed new first time period (TP1).

9. A controller according to claim 1, further comprising:
integrating means configured to integrate an output of said lamp driver and supply said signal indicating said first time period (T1) based on an integration result.

10. A controller according to claim 9, wherein said calculating means is further configured to determine a time between a point in time at which said integration result exceeds a specific threshold and a point in time at which a mains voltage of said dimmer falls below a certain level, subtract said determined time from a reference time period and integrate a subtraction result to obtain said proposed new first time period (TP1).

11. A controller according to claim 9, wherein said integrating means is further configured to be reset by said signal indicating said passive period.

12. An integrated circuit in which a controller according to claim 1 is integrated.

13. A lamp driver comprising:
a controller according to claim 1, wherein said controller is configured to control said lamp driver.

14. A system comprising:
a dimmer configured to vary a mean power and output said varied mean power;
a controller according to any one of claim 1;
a lamp driver supplied with said varied mean power; and
a lamp,
wherein said controller is configured to control said lamp driver and said lamp driver is configured to drive said lamp.

15. A system according to claim 14, wherein said lamp driver is an LED driver and said lamp is an LED lamp comprising LEDs.

16. A method of controlling a lamp driver supplied with an output of a phase cut dimmer, said method comprising:
enabling said lamp driver at a start time; and
disabling said lamp driver a first time period (T1) after said start time and before the end of an active period of said dimmer
sensing said active period of said dimmer based on said output of said dimmer and transmitting a start signal to enable said lamp driver;
sensing a passive period of said dimmer based on said output of said dimmer and generating a signal indicating said passive period;
calculating a proposed new first time period (TP1) based on said signal indicating said passive period and a signal indicating said first time period (T1); and
adapting said first time period (T1) based on said proposed new first time period (TP1).

17. A computer program product for a computer, comprising software code portions for performing the steps of a method according to claim 16 when said product is run on said computer.
